(19) United States
(12) Patent Application Publication
(10) Pub. No.: US 2022/0078965 A1
(43) Pub. Date: Mar. 17, 2022

(54) SEED CONGLOMERATION: A DISRUPTIVE INNOVATION TO REDUCE CLEANING REQUIREMENTS OF SMALL SEEDED SPECIES

(71) Applicants: Matthew David Madsen, Spanish Fork, UT (US); Rhett Michael Anderson, Salem, UT (US); Benjamin William Hoose, Nichols, NY (US)

(72) Inventors: Matthew David Madsen, Spanish Fork, UT (US); Rhett Michael Anderson, Salem, UT (US); Benjamin William Hoose, Nichols, NY (US)

(21) Appl. No.: 17/493,761

(22) Filed: Oct. 28, 2021

Related U.S. Application Data
(62) Division of application No. 16/262,864, filed on Jan. 30, 2019.
(60) Provisional application No. 62/623,928, filed on Jan. 30, 2018.

(51) Int. Cl. A01C 1/06; A01N 25/34

(52) U.S. Cl. CPC A01C 1/06; A01N 25/34

(57) ABSTRACT

Materials and methods are disclosed for conglomerating low-purity small seeds, clay-binder, and aeration media into a particle. Through this process a low purity seed does not inhibit seed flow through planting equipment because the seed and associated non-seed parts are formed into particles that have vastly improved flow and aerodynamic properties over untreated seed.

### CROSS REFERENCE TO RELATED APPLICATIONS

Priority is claimed from U.S. Provisional Patent Application 62/623,928, filed Jan. 30, 2018, which is hereby incorporated by reference.

### BACKGROUND

The sagebrush-steppe ecosystem is among the most imperiled biomes in the United States. Sagebrush restoration typically involves reseeding, however, seeding sagebrush is complicated by poor flow through seeders, low broadcast distance, and inconsistent seeding rates.

Small-seeded species like sagebrush are often difficult to clean due to the seeds having similar physical characteristics as their associate non-seed parts. These difficulties often make cleaning seeds to a high purity cost prohibitive (Welch 1996). For this reason, small seeds are typically not cleaned to a high purity. Leaving seeds uncleaned results in poor material flow.

The poor flowability of the seed can result in suboptimal seeding rates and clogging of the hopper seed outlet opening. To compensate for this, the hopper opening is adjusted to a wide opening, which is only partially effective. Additionally, when the seeder travels over a bump, it can knock the clogged seeds and other matter at the opening loose depositing the entire accumulation in one place. Even flow from a seed hopper is difficult or impossible to achieve, resulting in uneven distribution of the seed on the ground.

The aerodynamic properties of small seeds limits the distance seeds can be thrown and distributed from the seeder, and it can also lead to loss of the seed altogether if there is high winds.

There have been processes developed to coat or pelletize seeds, but because small seeds usually occur in nonuniform mixtures with other plant parts, which are often partially segregated or clumped together, this makes it difficult to apply current seed coating or pelletizing methods.

### SUMMARY

To address these problems, a system has been developed that forms a pellet or particle that is a conglomeration of seeds and plant parts. The conglomerate has improved flowability, and aerodynamic properties so seeding application is materially improved in uniformity, consistency of the distribution, wider coverage of each pass of the seeder, and an overall cost savings.

A conglomeration may comprise:
(1) small seeds of a seed size with a dimension less than 5 millimeters and including non-seed plant parts,
(2) clay-binder,
(3) aeration media, and
(4) optional additives.

Conglomeration technology can be applied to seeds of many species such as black sagebrush, low sagebrush, sand sagebrush, white sagebrush, fringed sagebrush, silver sagebrush, gray horsebrush, rabbitbrush, bud sagebrush, goldenweed, western yarrow, Nevada goldeneye, Canada goldenrod, blueleaf aster, Englemann aster, pacific aster, shrubby cinquefoil, and scarlett globemallow. Other suitable seeds include seeds of the genera Artemisia, Achillea, Chrysothamnus, Clematis, Dasiphora, Ericameria, Eucephalus, Eurybia, Heliomeris, Lorandersonia, Picrothamnus, Pyrrocoma, Senecio, Solidago, Sphaeralcea, Symphyotrichum, Tetradymia

The clay-binder can be any clay capable of forming suitable conglomerates. Suitable conglomerates are sturdy and robust enough to withstand handling, shipping, storage, and application and distribution with a seeder. However, it cannot be too hard and firm, and must be sufficiently friable so that it can soften and disintegrate when wetted. Properties can be modified and the conglomerate made more friable by varying the amount and quality of aeration media. The firmness of the conglomerate may also be enhanced by a liquid or water soluble polymer binder applied in the manufacture as a solution with the water.

The aeration media may be any suitable plant based organic matter, such as ground-up garden and farm waste, tree bark, wood, or stems and seed fragments of any species, such as husks, flour, and the like. This includes any material conventionally used for compost. The aeration media can also be made from various commonly used soil potting media such as perlite and vermiculite.

The present conglomerate system also has the added benefit of providing an effective way to add additives to the seed. The conglomerates can easily incorporate additives to improve or regulate growth of plants or for other purposes, these include, fungicides, plant growth hormones, fertilizer, biologicals, and the like. This is a unique property in sagebrush seeding systems and can become a major advance of this technology. Biological additives may include symbiotic organisms, fungi, bacteria, molds, multicell or single-cell organisms, nematodes, insects, or any suitable biological component to regulate or improve germination or growth of the seeds. This include spores, eggs, seeds or other dormant forms any of the above.

The additives may also include plant hormones that are used to regulate plant growth and germination, but currently cannot be used in small seed applications. These hormones include abscisic acid, auxins, brassinosteroids, cytokinins, gibberellins, jasmonates, salicylic acid, strigolactones, plant peptide homones, polyamines, nitric oxide producters, ethylne producers, karrikins, and triacontanol.

The present system is advantageous for application of sagebrush seed, and can be applied to other small seeds. Conglomeration is likely to be most effective for seeds that have a dimension of about 5 millimeters or less. Conglomeration my be especially useful for seed that have a dimension shorter than 2 millimeters. The dimension may include major or minor dimensions of the seed size, and can include longer, small, thin seeds.

Conglomerates can be made by method by first providing a mixture of solid materials comprising small seeds of a seed size having a dimension less than 5 millimeters and including non-seed plant parts, clay-binder, and aeration media. The mixture is subjected to a centrifugal force while adding or metering water at a controlled rate to the mixture. Water addition is continued while conglomerated particles form. Water addition is stopped or ceased when conglomerated particles are of sufficient size. To further form the conglomerated particles, additional clay-binder in solid form is added to the wetted solid mixture. More water is then added to further coat the conglomerated particles with clay-binder. At this water addition, a soluble binder or polymer may be added to the water to further improve the conglomeration integrity. The conglomerated particles are then dried to remove water.

This method differs from current seed coating practices in that the solid materials are added with the seed at the beginning of the process; centrifugal forces and the addition of liquid then allows the material to conglomerate together, thus providing a different approach to treating seed with low purity.

The present system has been developed within a rotary coater that allows for the conglomeration of sagebrush seed using a combination of clay-binder, compost, water, and binder. Trials were performed on Wyoming big sagebrush (Artemisia tridentata. ssp. wyomingensis). In a trial, a brodcase seeder distributed congloverated seeds more than twice as far as untreated seeds (7 meters for conglomerates verses 3 meters for untreated seed). Conglomerates ability to be broadcast further than untreated seed, directly lowered the overall cost to seed an area by approximately $8 ha⁻¹.

Improved flowability of conglomerates over untreated seeds was demonstrated through measurements of the Hausner ratio (8% decrease), the angle of repose (21% decrease) and delivery through a broadcast seeder.

Laboratory trials evaluated germination over five temperatures ranging from 5-25° C. and showed that on average conglomerates increased seed germination by 15%. Field trials at two sites demonstrated that seedling emergence was similar for untreated and conglomerated seed. With no deleterious effects observed from the conglomeration treatment, additional research is merited for using conglomerates as a platform to apply various additives, such as fungicides, plant growth hormones, fertilizers, biologicals, and others. The potential outcomes of these strategies may have a significant impact on future seeding attempts by improving seed delivery, decreasing seeding costs, and increasing overall seeding success. The conglomerate approach proposed in this disclosure could serve as a seed treatment for other species in a variety of systems.

### Advantages of Present Process

Use of the current system can have advantageous implications, including:
Increased broadcast distance provided by conglomerates may reduce seeding costs by decreasing the number of passes required by an operator to cover the target area with seed.
Conglomerates may reduce the need for seed carriers, such as rice hulls, or other species that may be needed to improve flow out of the seed box.
Improved seed flowability provided by conglomerates over uneven terrain should allow for a more accurate and uniform distribution of seeds.

The present conglomeration process represents a disruptive innovation technique for replacing ineffective seed cleaning treatments that are currently being used on small-seeded species. Seeds are typically separated from non-seed material during the cleaning process using mills, de-bearders, screens or fans that capitalize on differences in various physical characteristics such as seed shape, size, or density (Jacobs et al. 2011). Small-seeded species are often difficult to clean due to the seeds having similar physical characteristics as their associate non-seed parts. Small-seeded species can be costly due in part to the time consuming and inefficient methods used to clean them (Welch 1996). To lower seed costs, these types of seeds are typically not cleaned to high purity. Low purity seeds have poor flow properties which cause challenges when practitioners try to sow the seed, such as bridging, rat holing, and clogging within the planting equipment.

The present conglomerate system is particularly adapted to successfully sow such low purity seeds. The problems of bridging, rat holing, and clogging are essentially eliminated, and sowing throw distance is improved.

Rather than attempting to clean these small low purity seeds, as has been attempted in the past, the present system takes a far different approach by conglomerating together the seeds along with the associated non-seed parts to form particles that have vastly improved flow properties and aerodynamic properties.

Innovation Over Prior Systems

The current system circumvents the need to clean small-seeded species to a high purity by conglomerating the seed with its associated non-seed parts, into spherical clay based particles or pellets. These pellets are formulated to have enhanced flow properties, which allow the seeds to be delivered through standard planting equipment and thus eliminate the need for costly techniques for cleaning the seed to high purities.

Seed conglomerates also eliminate the need for applying filler material with the seed. When small-seeded species are cleaned to a high purity, they are difficult to plant because the seeds separate from other types of seeds within the seed box. Additional planting equipment is typically not capable of metering and distributing the seeds. In this case, filler materials (such as rice hulls) are often needed to help distribute the seed.

The increased mass provided by the present seed conglomerating technique makes small seeds have similar physical properties as the other larger seeds in the seed mix, which keeps the seeds from separating from one another.

Another advantage is that the increased bulk provided by the material used to form the conglomerate particles improves the ability of the planter to distribute a relatively small amount of seeds across a large area.

Sagebrush seed is a prime example of a small seeded species that is difficult to clean to a high purity that would benefit from our seed conglomeration process (Welch 1996; Jacobs et al. 2011). Other species with small seed and low purity, such as black sagebrush, low sagebrush, sand sagebrush, white sagebrush, fringed sagebrush, silver sagebrush, gray horsebrush, rabbitbrush, bud sagebrush, goldenweed, western yarrow, Nevada goldeneye, Canada goldenrod, blueleaf aster, Englemann aster, pacific aster, shrubby cinquefoil, and scarlett globemallow, also make good candidates for conglomeration.

### BRIEF DESCRIPTION OF DRAWINGS

FIG. 1A is a photo of untreated (control) Wyoming big sagebrush (Artemisia tridentata Nutt. ssp. wyomingensis [Beetle & A. Young] S. L. Welsh) seed with a United States penny for scale.

FIG. 1B is a photo of the seed shown in FIG. 1A that has been conglomerated.

FIG. 2 is a graph showing the influence of the number of bumps driven over on the change in seeding rate from a tractor being idle, for both untreated seed (control) and conglomerated seed.

FIG. 3 is a graph showing the influence of untreated (control) and conglomerated Wyoming big sagebrush seed on final germination percentage (mean±SE) at temperatures ranging from 5-25° C. Single asterisks indicate a difference in germination (P<0.05) between the treatments at the specific temperature.

FIG. 4 is a graph showing the cost of seeding one hectare of land for both control and conglomerated seed. The cost has been broken down into cost of seed (seed), the cost to produce the conglomerates in a seed coating facility, which includes materials, shipping and labor (treatment), and cost to apply the seed (seeding). Error bars represent the standard error surrounding the cost of seeding as a function of broadcast distance.

FIG. 5 is a graph showing seeding rates of control and conglomerated seed across broadcast seeder opener settings.

FIG. 6A s a graph showing the time to reach 50% germination for control and conglomerated seed at temperatures ranging from 5-25° C.

FIG. 6B is a graph showing germination synchrony (mean±SE) for control and conglomerated seed at temperatures ranging from 5-25° C. An asterisk indicates a difference in germination (P<0.05) between the treatments at that temperature.

FIG. 7 is a graph showing total monthly precipitation over the study (2016-2017) and 30-yr average precipitation (1981-2010) at research sites near Lookout Pass and Santaquin Utah. Data was derived from models developed by PRISM's Oregon Climate Service.

FIG. 8 shows box plots showing emergence for untreated (control) and conglomerated seed at two different study sites (Santaquin and Lookout Pass, Utah, U.S.A) counted in May 2017. The box limits indicate the 25th to 75th percentiles, the solid line within the box is the mean. The upper and lower bars represent the range from 10th to 90th percentile, and the individual dots represent outliers.

### DETAILED DESCRIPTION

Drylands, which encompass arid and semi-arid ecosystems, span over one-third of the Earth's landscape (Anderson & Inouye 2001; James et al. 2013). Millions of hectares of drylands are degraded resulting in the loss of over US $40 billion dollars in productivity (Brauch & Oswald 2009; Kildisheva et al. 2016). Current restoration practices do not fully address the technology and management needs necessary to restore drylands with the diversity of plants needed to sustain various animal and microorganisms, and reinstate ecosystem process and function (James et al. 2013; Kildisheva et al. 2016). Lack of plant diversity can be caused, in part, by poor seeding success of small seeds (Chambers 2000; Leishman et al. 2000). Small seeds present several logistical challenges associated with their cleaning, handling, delivery, and placement in the soil (Welch 1996; Chambers 2000; Shaw et al. 2005). Because of these challenges, restoration efforts commonly exclude small-seeded species or plant them in low quantities (Richards et al. 1998; Chambers 2000).

One specific case where a small-seeded species typically has low restoration success is sagebrush (Artemisia spp.) (Arkle et al. 2014; Brabec et al. 2015). The sagebrush steppe ecosystem is one of the most widespread semi-arid ecosystem in North America, spanning across much of the Western United States (Pyke et al. 2015) and is considered critically endangered due to impacts from grazing, altered fire regimes, invasive species, and various human disturbances (Knick et al. 2011; Davies et al. 2014). Despite large expenditures, the success of sagebrush restoration projects is low and often sporadic, particularly within the hotter, drier, lower elevation sites (Davies et al. 2011; Madsen et al. 2016b; Svejcar et al. 2017).

Technologies that improve seeding success or lower seeding cost are necessary for sagebrush restoration efforts to be economically feasible (Taylor et al. 2013; Madsen et al. 2016b; Svejcar et al. 2017). One of the difficulties associated with sagebrush seeding is the complications that arise with delivering seed through broadcast and drill seeders (Shaw et al. 2005). Sagebrush seed lots are typically low in purity, containing approximately 70-90% non-seed parts (i.e. seed bracts, leaves, and fine stems) (Jacobs et al. 2011). These non-seed parts can cause clogging within the seed box, which reduces the flow of seed from the planter or broadcast seeder (Shannon 1979). Furthermore, the small seed size of sagebrush (˜1 to 2 mm or less) may result in the seed separating from other species in the mix during the seeding operation, which results in variable sagebrush seeding rates across the restoration area (St. John et al. 2012). Sagebrush seed is generally broadcast due to its inability to emerge from below the soil surface (Lysne & Pellant 2004; Ott et al. 2017). When small seeds, such as sagebrush, are broadcast aerially or by ground broadcast spreaders they have the potential to drift from the targeted seeding area (Chambers 2000; Groen & Woods 2008).

Technological enhancements to improve dryland seeding have begun to emerge in the form of seed coatings (Guzzomi et al. 2016; Madsen et al. 2016a; Pedrini et al. 2016). Emerging seed coating technologies have been tested for various species and designed to address specific problems associated with seed germination, plant establishment, and seed delivery (Madsen et al. 2013). Seeds are commonly coated in rotary coaters using centrifugal forces to mix the seeds, while adhesives (or binders) are pumped to the center of the coating chamber onto an atomizing disk, which redirects the liquid outward in small droplets onto the seed. With a binder providing a tacky base, coating powder is delivered through an auger feeder onto the moist seeds. This process is repeated until the coating has reached the desired thickness. Due to the low purity and small size of sagebrush seed, standard procedures that are designed to evenly coat individual seeds cannot be applied in a rotary seed coater.

A new present procedure has been developed that allows for the coating of sagebrush seed by clustering or conglomerating the seed with associated non-seed parts into relatively uniform spherical shaped conglomerates about 2-4 mm in diameter. Sagebrush conglomerates are formed by mixing seed, aeration medium and clay in a rotary seed coater, and then while spinning the medium, water, an additional clay amount, and binder are added in separate steps. This may provide a major step forward in the treatment of sagebrush seed and other small seeded species.

Procedures for grouping medium to large grass seeds of the same species have been proposed in the literature (Madsen et al. 2012). This process demonstrated grass seeds could be grouped by applying binder and diatomaceous earth in alternating steps. Through Madsen et al. (2012) approach the binder is applied in excess to cause clumping of the seeds.

Various extrusion techniques have also been applied to form seeds together with various filler materials, to form pellets (Madsen et al. 2016b), pods (Madsen et al. 2014), and pillows (Madsen et al. 2016a). A current finding is that the agglomeration procedures proposed by Madsen et al. (2012) are not capable of forming uniform particles with sagebrush and other small seeded species that are difficult to clean, and seed extrusion techniques are relatively inefficient to apply.

The current conglomeration technique allows for the uniform conglomeration of sagebrush seed and other materials within a rotary seed coater. The efficiency of the rotary seed coater in treating seeds and its widespread use in commercial seed coating facilities makes this technology highly transferable. This technology is likely to be transferable to other restoration species with small seeds and low seed purity.

Discussed in this disclosure are: 1) present sagebrush conglomerates improve the flow rate and delivery of seed like those of Wyoming big sagebrush (Artemisia tridentata Nutt. ssp. wyomingensis [Beetle & A. Young] S. L. Welsh) seed, 2) the influence of conglomeration on seed germination and seedling emergence, and 3) if conglomeration is an economically viable treatment. The improved flow properties of sagebrush seed and the current sagebrush conglomerates have the potential to improve sagebrush delivery and lower seeding costs.

Materials and Methods

Trials were performed on Wyoming big sagebrush seed, obtained from Granite Seed and Erosion Control (Lehi, Utah, USA). Seed was previously cleaned to 30% purity and had a viability of 80%. Seed coating was performed at Brigham Young University Seed Enhancement Laboratory following the procedure described in Appendix S1. We counted the number of seeds in individual conglomerates from seven replicate 0.1 g samples to determine the average number of seeds per individual conglomerates.

Laboratory Tests of Flowability

The flow properties of untreated and conglomerated seed were compared by determining their Hausner ratio and the angle of repose. The Hausner ratio compares bulk and tap densities where a lower ratio between the two densities indicates an increase in flowability. Bulk density was calculated using 3 replicate 300 ml samples of each treatment. Tapped density was measured by tapping five replicate 300 ml sample in a cylinder 40 times, from a height of 15 cm, and then using the new volume to calculate density.

The angle of repose was determined by producing a cone-shaped pile by pouring a 1000 ml sample of material through a 3 cm pipe that was placed in a fixed position with the bottom of the opening 20 cm above a flat surface. The angle of repose was calculated by taking the inverse tangent of the height of the cone divided by the radius of the base of the cone. This procedure was repeated with independent samples five times with the order of treatment randomized.

Broadcast Distance and Delivery Rates from a SeederEvaluations were performed using a Muratori 500 spreader (Muratori Castelnuovo Rangone, Mo., IT) attached to a John Deere 5520 tractor (John Deere, Moline, Ill., USA). During all evaluations, the engine was operated at 1600 revolutions per minute (RPM). Broadcast distance was measured of untreated (control) and conglomerated seed by operating the broadcast seeder for thirty seconds and then measuring the width of the broadcasted swath. The width of the broadcast swath was considered to be the longest distance perpendicular to the tractor within which the distribution of seed was relatively uniform. Three replicate distance measurements were made for the control and conglomerated seed, with the order of the treatment randomized. This broadcast distance was used to calculate flow rate across a range of lever opening positions of the hopper (Appendix S2).

Analysis of Seeding Costs

The cost ha⁻¹ of planting control verses conglomerated seed was compared with seed delivered with the same tractor and broadcast spreader described above. In the analysis, the cost of producing and shipping conglomerates, the broadcast distance of each treatment, the kg of pure live seed (PLS) L⁻¹ of each treatment, and the labor and tractor costs associated with seeding (Appendix S4) were taken into account.

Seed Delivery Over Uneven Terrain

Sagebrush seed delivery over uneven terrain was evaluated on a 100 m track that included either 0, 5, or 10 evenly spaced bumps. The bumps consisted of 38 mm tall×89 mm wide boards screwed into 38 mm tall×136 mm wide boards to create 76 mm tall, tiered bumps. The broadcast seeder was calibrated, with the tractor stationary, to deliver approximately 0.2 kg PLS ha⁻¹ prior to traversing the track. After calibration, the track was traversed at each of the three bump quantities and randomized the order of which bump quantity was tested. This procedure was repeated seven times for each seed treatment, with the order of the treatment randomized. During operation, approximately 15 kg of seed were kept in the hopper with the P.T.O set at 1600 RPM. The tractor was operated at approximately 2.2 m s⁻¹. The output seed was collected and weighed after each run, and the seeding rate was calculated.

Evaluation of Germination of Emergence

Laboratory trials conducted to determine conglomeration treatment effects on sagebrush seed percent germination, germination rate, and synchrony (Appendix S3). Field trials were also conducted to evaluate the effect of the conglomeration treatment on seedling emergence on a degraded Wyoming big sagebrush site approximately 16 km south of Santaquin, Utah, U.S.A. (lat 39°54′35″N log 111°48′45″W), and a crested wheatgrass (Agropyron cristatum [L.] Gaertn) seeding 2 km east of Lookout Pass, Utah, U.S.A. (Appendix S3).

Statistical Analysis

Statistical analysis was performed using JMP®, Version 13 (SAS Institute Inc., Cary, N.C., U.S.A.). Broadcast distance of control and conglomerated seed was compared using a two-sample t-test. Tested was the null hypothesis that there is no interaction between the seed treatment and the number of bumps using multiple regression with standard least squares fitting. Student's t tests were used to compute individual pairwise comparisons between the seed treatments with different numbers of bumps. Mixed model analysis was used to analyze the effect that conglomerates have in relation to final germination percentage, T₅₀, and synchrony. In the model, block was considered a random factor while incubation temperature, seed treatment, and the interaction of temperature X treatment were analyzed as fixed factors. Differences were tested for in the response of conglomerated seed compared to control seed at the incubation temperatures of 5, 10, 15, 20, and 25° C. using a single-tailed t-test. Because residual plots and linearity tests indicated that T₅O and synchrony values violated statistical assumptions for equal standard deviation and linearity, they were log transformed. Sagebrush seedling density in the field was analyzed using a mixed model analysis with blocks considered random and treatment, study site, and the interaction of treatment x study site being fixed factors. For all statistical comparisons a significance level of P<0.05 was used; values are reported as mean±standard error (SE).

Results

Seed Flowability

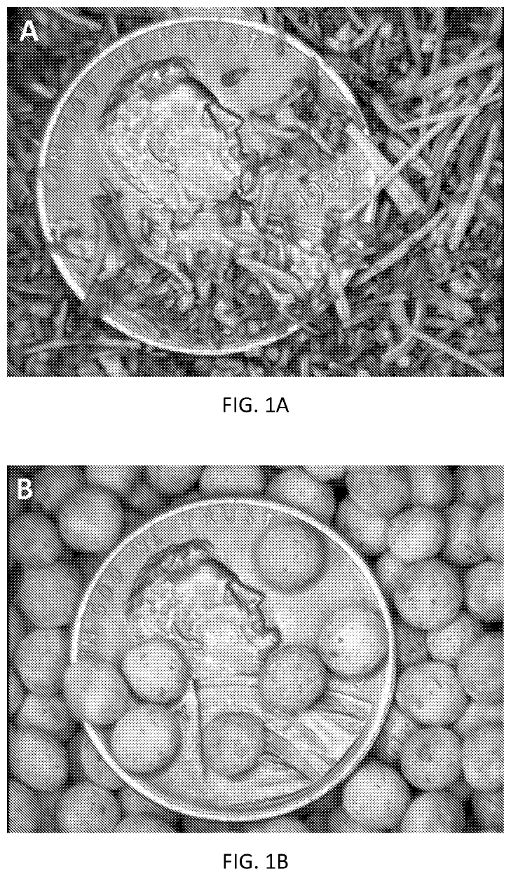

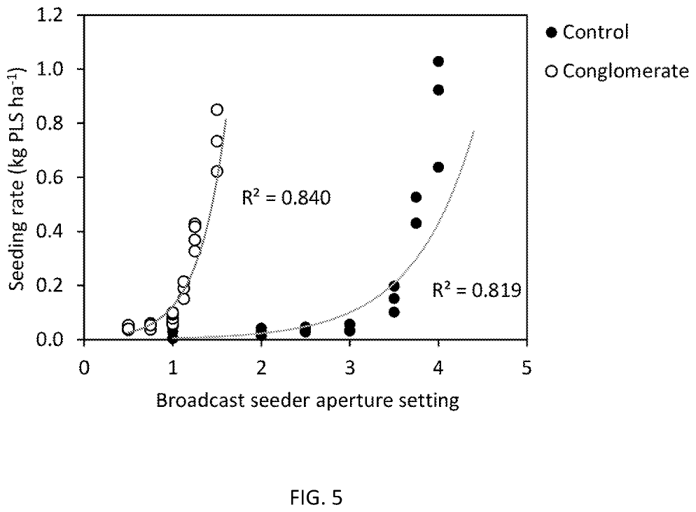

Relatively uniform, spherical conglomerates of sagebrush seed were produced through the conglomeration treatment used in this study (FIG. 1), with the average number of seeds per individual conglomerate equal to 0.68±0.17 seeds. Recorded was an average Hausner ratio of 1.23±0.018 for the control and 1.13±0.004 for conglomerated seed (t_{5.6}=4.95, P=0.003). A Hausner ratio closer to 1.0 is indicative of better flow. Improved flowability through conglomeration was also indicated through the angle of repose measurement. The angle of repose of control and conglomerated seed was 43°±1.9° and 34°±0.8°, respectively (t_{5.3}=4.51, P=0.005). Flow rates from the broadcast seeder were minimal (≤0.06 kg PLS ha⁻¹) for control seed until the lever opening position was adjusted to 3.0 (FIG. 5). In contrast, improved flow properties of the conglomeration treatment resulted in relatively high seed delivery at lever opening position 1.0 (≈0.09 kg PLS ha⁻¹), with the rate of seed flow increasing with increasing lever opening positions (FIG. 5).

Evaluation of Broadcast Seeding Distance

Conglomerated seed was broadcast 2.2 times further than control seed (t_{3.5}=11.75, P<0.001). Control seed was broadcast an average distance of 3.09±0.18 m and conglomerated seed was broadcast an average distance of 6.91±0.27 m. Thus, for every 100 m driven with a broadcast seeder approximately 310 m² and 690 m² of land is seeded with control and conglomerated seed, respectively.

Evaluation of Seed Delivery Over Uneven Terrain

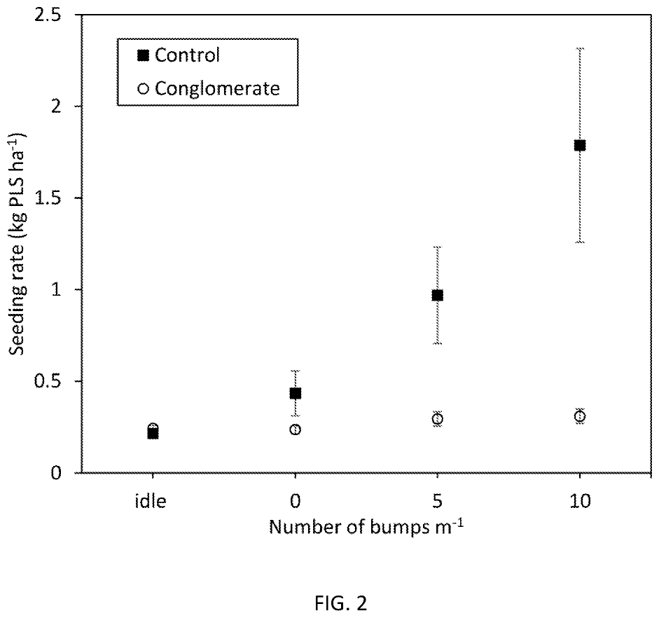

The type of seed treatment (F_{3, 14}=6.52, P=0.006) and the number of bumps (F_{3, 14}=6.52, P=0.041) had a strong influence on seeding rate. When control seed was broadcast, the amount of seed that was delivered drastically increased with increasing number of bumps and became more variable (FIG. 2). In contrast, the seeding rate of the conglomeration treatment remained constant, regardless of the number of bumps (FIG. 2).

Lab Seed Germination

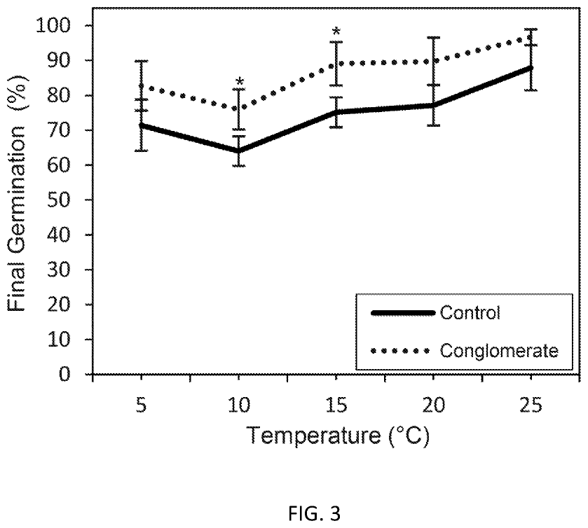

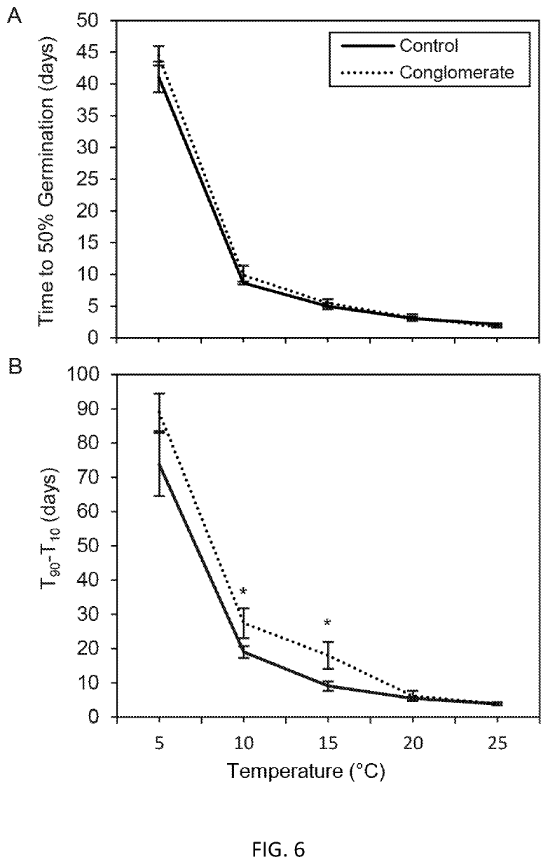

Across all temperatures, final germination percentage on average was 15% higher for conglomerated seed (F_{1, 54}=9.55, P<0.01) (FIG. 3). At 10, 15, and 20° C. final germination percentage of the conglomerates was 17, 17, and 15% higher, than the control, respectively; while at 5 and 25° C., a treatment effect was not detected (FIG. 3). Analysis of T₅₀ was not influenced by seed treatment (F_{1, 54}=0.01, P=0.93). However, germination synchrony was influenced by seed treatment (F_{1, 54}=7.65, P <0.01) (FIG. 6B) and temperature (F_{4, 54}=162.01, P<0.01). At 10 and 15° C., conglomerates slightly decreased synchrony by 8.44 and 8.97 d, respectively, in comparison to the control (FIG. 6B). As with T₅₀, as temperature increased germination synchrony decreased, with sharp contrasts between 5 and 10° C. (FIG. 6A, 6B).

Field Emergence

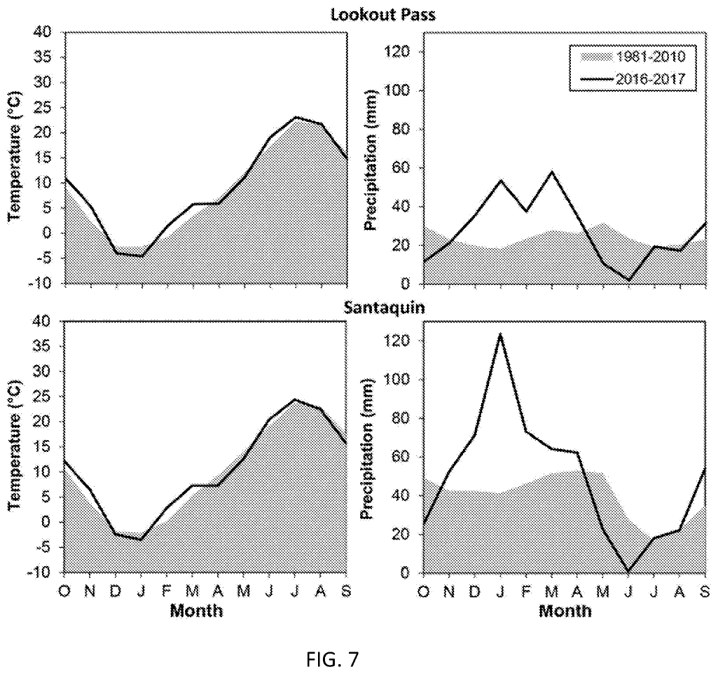

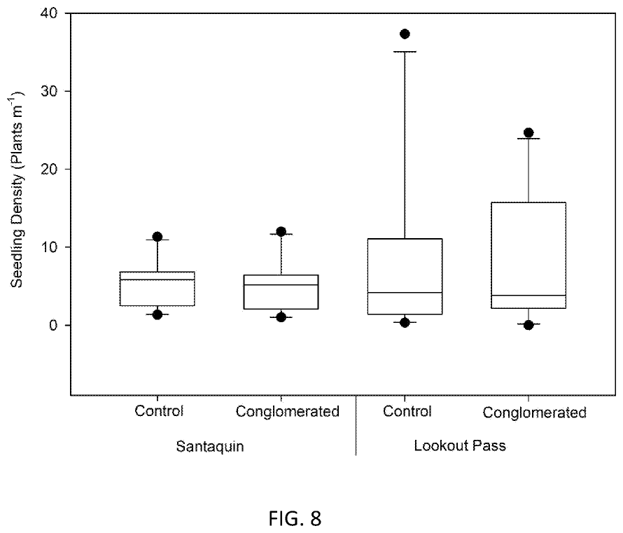

Precipitation after planting was relatively low in fall, high in winter (near double) and spring, minimal in summer and near average towards the end of summer (FIG. 7). The amount of emerged seedlings was not influenced by seed treatment (F_{1, 18}=0.17, P=0.80), site (F_{1, 18}=0.82, P=0.38), or the interaction between them (F_{1, 18}=0.07, P=0.80). Both seeding treatments had relatively high seeding success rates.) (FIG. 8).

Analysis of Seeding Costs

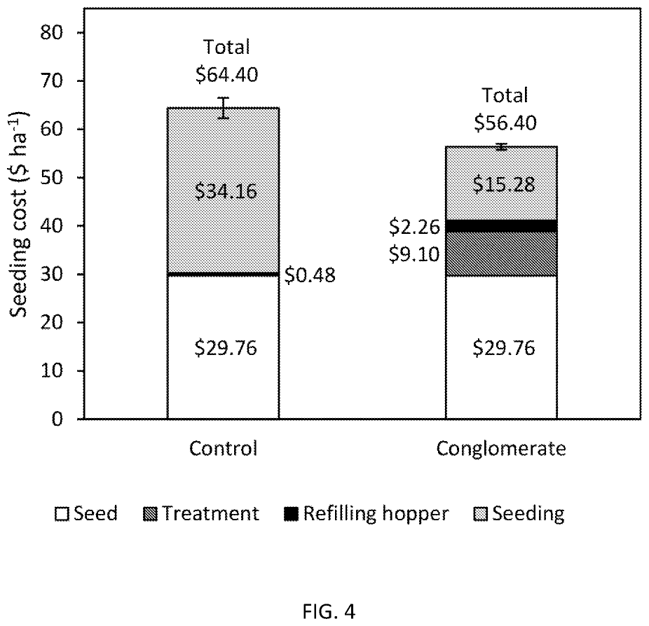

The estimated cost for Wyoming big sagebrush seed would be $29.76 ha⁻¹, and that conglomerating would add an additional cost of $9.10 ha⁻¹ in labor and material (FIG. 4). The cost to broadcast untreated seed was estimated to be $34.64±0.18 ha⁻¹, while conglomerated seed was estimated to be $17.54±0.27 ha⁻¹. Based on these estimates, it appears that the cost to broadcast conglomerated seed offsets the cost of producing the conglomerates and saves an additional $8.00 ha⁻¹. However, the actual savings will vary depending on the cost of producing conglomerates, the hourly labor and tractor costs, the variation in broadcast distance associated with different broadcast seeders, the P.T.O. speed, and the broadcast seeder capacity.

Discussion

There have been few improvements in the technologies used for rangeland restoration over the last several decades. Seed coating in itself is a relatively new technique in rangeland restoration, but is quickly gaining headway as more research demonstrates its potential benefits (Madsen et al. 2016a). The results provide evidence that conglomerating sagebrush seeds produced a smaller Hausner ratio, and minimized the angle of repose, which demonstrates improved flowability of conglomerates compared to untreated seed.

Enhanced seed flow characteristics may improve land managers' ability to distribute seed across the landscape and reduce labor associated with mixing, handling, and seeding because conglomerated seed is less likely to clog seed mixers, hoppers and seeders. Seeding rates are often chosen to introduce sufficient seed to restore the system while staying below the constraints of intraspecific competition and cost (Monsen et al. 2004). For sagebrush, the cost is usually more limiting than intraspecific competition (Boyd & Obradovich 2014; Ott et al. 2017). Thus, consistent seeding rates are more efficient and more cost effective. Natural bumps in the terrain can cause the seeding rate to increase in a multiplicative manner, thereby wasting seed. The research indicates that the seeding rate of untreated sagebrush seed can be highly influenced by the terrain that the tractor is driving over. It was found that as the number of bumps the tractor drives over increases, the rate that seed is delivered also increases and becomes more variable. In contrast, conglomerated seed maintained a similar seeding rate, regardless of the number of bumps that were driven over. It was observed that seeding rates of untreated seed can be impacted by terrain because the lever opening position on the broadcast seeder must be opened most of the way to allow the seed to flow. The results show that when the tractor is impacted by a bump, clumps of seed can be dislodged and quickly flow out of the hopper. In contrast, improved flowability from the conglomerates allowed the target seeding rate to be achieved with a relatively low lever opening position, which minimized the chances of clumps of seed coming out of the broadcast seeder when the tractor passed over jarring terrain.

Conglomerating sagebrush also gives managers the ability to think in terms of altering the seed instead of altering the machinery or various other logistical aspects associated with seeding. The laboratory experiments demonstrated that in controlled conditions conglomerates provided a moderate increase in overall seed germination and spread the period over which seeds germinate (i.e. decreased synchrony). Field trials performed at two different sites did not show a difference in seedling emergence between the control and conglomerated seed and both treatments were successful at producing an adequate number of sagebrush plants, which may be due to favorable soil moisture and temperature conditions during the study period. It is unclear if the conglomerate formulation used in this study would improve sagebrush establishment during years with less favorable climatic conditions. However, the conglomerate platform does provide a means to apply enhancements to sagebrush seed that should improve sagebrush establishment. Additional research is now merited for using conglomerates to apply various seed enhancements such as: fungicides, plant growth hormones, herbicide protectants (i.e. activated carbon), water absorbent polymers, fertilizers, biologicals, soil surfactants and other treatments that may address factors controlling sagebrush recruitment (Madsen et al. 2016a; Guzzomi et al. 2016; Pedrini et al. 2016).

Sagebrush conglomerates also improve seeding efforts by enhancing the ballistic properties of the seed. It was found sagebrush conglomerates could be broadcast 2.2 times further than untreated seed. Broadcasting conglomerated seed reduces costs associated with labor and the use of seeding equipment because more area can be seeded per unit of time holding all else constant. It was estimated that the increased broadcast distance from the conglomerated seed could save approximately $8.00 ha⁻¹. Although a hopper can hold nearly five times more untreated seed than conglomerated seed on a PLS basis, typical seeding rates are so low that the additional cost to refill a hopper of conglomerates is far exceeded by the savings achieved by increased broadcast distance (see FIG. 4). Furthermore, high volumes of rice hulls or other seed carriers are often added to untreated seed to improve flow (St. John et al. 2012). Seed carriers increase the kg PLS L⁻¹ and add to the cost of seeding (Table S1). Not having to mix rice hulls or other carriers with sagebrush seed could further decrease overall seeding costs.

Cost savings associated with the conglomeration treatment could be viewed as even greater if considering the poor seeding success that typically occurs for Wyoming big sagebrush. The actual cost of a successful restoration treatment on a unit area basis can be thought of as the cost of the treatment divided by the probability of success (Boyd & Davies 2012). A conservative estimate of the success rate of sagebrush establishment following broadcast seeding is 30% (Lysne & Pellent 2004; Boyd & Obradovich 2014), though the true probability is likely to be lower due to the underreporting of negative results in the literature (Hardegree et al. 2011). Thus, if conglomerated seed incurs a savings of $8.00 ha⁻¹, this would translate to $26.67 per successfully restored hectare. These savings become important over the large spatial and temporal scales typical of restoration efforts in the western United States.

Sagebrush seed conglomeration is a technology that lowers seeding cost, and marks an important step toward making sagebrush restoration efforts economically efficient. Future studies are necessary to explore similar benefits or limitations of seeding sagebrush conglomerates through rangeland drills and aerial seeders. The conglomeration approach proposed in this study could potentially serve as a seed treatment for other small-seeded species in a variety of restoration scenarios internationally.

TABLE S1
Estimates for producing current sagebrush conglomerates broken
down by the cost to purchase the materials, cost to ship the materials
and seed to a commercial seed coating facility, and cost to produce
the conglomerates. Estimates are provided on a cost per kg of
seed⁻¹ and cost ha⁻¹.

| Item | Price kg seed⁻¹ | Cost ha⁻¹ |
|---|---|---|
| Azomite | $0.35 | $0.40 |
| Compost | $0.12 | $0.14 |
| Binder | $5.00 | $5.64 |
| Shipping | $0.29 | $0.33 |
| Treatment | $2.31 | $2.60 |
| Total cost | $8.08 | $9.10 |

### TABLE OF LITERATURE CITED

Anderson J E, Inouye R S (2001) Landscape-scale changes in plant species abundance and biodiversity of a sagebrush steppe over 45 years. Ecological Monographs 71:531-556
Arkle R S, Pilliod D S, Hanser S E, Brooks M L, Chambers J C, Grace J B, Knutson K C, Pyke D A, Welty J L, Wirth T A (2014) Quantifying restoration effectiveness using multi-scale habitat models: Implications for sage-grouse in the great basin. Ecosphere 5:1-32
Boyd C S, Davies K W (2012) Spatial Variability in Cost and Success of Revegetation in a Wyoming Big Sagebrush Community. Environmental Management 50:441-450
Boyd C S, Obradovich M (2014) Is Pile Seeding Wyoming Big Sagebrush (Artemisia tridentata subsp wyomingensis) an Effective Alternative to Broadcast Seeding? Rangeland Ecology & Management 67:292-297
Brabec M M, Germino M J, Shinneman D J, Pilliod D S, McIlroy S K, Arkle R S (2015) Challenges of establishing big sagebrush (Artemisia tridentata) in rangeland restoration: effects of herbicide, mowing, whole-community seeding, and sagebrush seed sources. Rangeland Ecology & Management 68:432-435
Chambers J C (2000) Seed movements and seedling fates in disturbed sagebrush steppe ecosystems: Implications for restoration. Ecological Applications 10:1400-1413
Davies K W, Bates J D, Madsen M D, Nafus A M (2014) Restoration of mountain big sagebrush steppe following prescribed burning to control western juniper. Environmental Management 53:1015-1022
Davies K W, Boyd C S, Beck J L, Bates J D, Svejcar T J, Gregg M A (2011) Saving the sagebrush sea: An ecosystem conservation plan for big sagebrush plant communities. Biological Conservation 144:2573-2584
Erickson T E, Barrett R L, Symons D R, Turner S R, Merritt D J (2016) An atlas to the plants and seeds of the Pilbara region. In ‘Pilbara seed atlas and field guide: plant restoration in Australia's arid northwest’. (Eds T E Erickson, R L Barrett, D J Merritt and K W Dixon) pp. 43-256. (CSIRO Publishing: Dickson, Australian Capital Territory).
Groen A H, Woods S W (2008) Effectiveness of aerial seeding and straw mulch for reducing post-wildfire erosion, north-western montana, USA. International Journal of Wildland Fire 17:559-571
Guzzomi A L, Erickson T E, Ling K Y, Dixon K W, Merritt D J (2016) Flash flaming effectively removes appendages and improves the seed coating potential of grass florets. Restoration Ecology 24:S98-S105
Hardegree S P, Jones T A, Roundy B A, Shaw N L, Monaco T A (2011) Assessment of range planting as a conservation practice (chapter 4). Pages 171-212. In: Briske D D (ed) Conservation benefits of rangeland practices: assessment, recommendations, and knowledge gaps. US Department of Agriculture, Natural Resources Conservation Service, Washington D.C.
Hoose B W, Call R S, Bates T H, Anderson R M, Roundy B A, Madsen M D (In Review) Seed Agglomeration: A Novel Approach to Increasing Realized Diversity of Small-Seeded Species in Restoration. In Review with Restoration Ecology (accepted with revisions September 2018).
Jacobs J, Scianna J D, and Winslow S R (2011) Plant materials technical note: Big sagebrush establishment. United States Department of Agriculture.
James J J, Sheley R L, Erickson T, Rollins K S, Taylor M H, Dixon K W (2013) A systems approach to restoring degraded drylands. Journal of Applied Ecology 50:730-739
Kildisheva O A, Erickson T E, Merritt D J, Dixon K W (2016) Setting the scene for dryland recovery: An overview and key findings from a workshop targeting seed-based restoration. Restoration Ecology 24:S36-S42
Knick S T, Hanser S E, Miller R F, Pyke D A, Wisdom M J, Finn S P, Rinkes E T, Henny C J (2011) Ecological influence and pathways of land use in sagebrush. Studies in Avian Biology 38:203-251
Leishman M R, Wright I J, Moles A T, Westoby M (2000) The evolutionary ecology of seed size. In M. Fenner (Ed.), Seeds: the ecology of regeneration in plant communities (2nd ed., pp. 31-57). Oxon, UK: CABI International.
Lysne C R, Pellant M L (2004) Establishment of aerially seeded big sagebrush following southern Idaho wildfires. Tech. Bull. 2004-01. Boise, Id.: USDI Bureau of Land Management, Idaho State Office. 14 p.
Madsen M D, Davies K W, Boyd C S, Kerby J D, Carter D L, Svejcar T J (2013) Restoring North America's sagebrush steppe ecosystem using seed enhancement technologies. Pages 393-401 Proceedings of the 22nd international grassland congress
Madsen M D, Davies K W, Boyd C S, Kerby J D, Svejcar T J (2016a) Emerging seed enhancement technologies for overcoming barriers to restoration. Restoration Ecology 24:S77-S84
Madsen M D, Davies K W, Williams C J, Svejcar T J (2012) Agglomerating seeds to enhance native seedling emergence and growth. Journal of Applied Ecology 49:431-438
Madsen M D, Hulet A, Phillips K, Staley J L, Davies K W, Svejcar T J (2016b) Extruded seed pellets: A novel approach for enhancing sagebrush seedling emergence. Native Plants Journal 17:230-243
Monsen S B, Stevens R, Shaw N L (2004) Restoring western ranges and wildlands. Gen. Tech. Rep. RMRS-GTR-136-vol-1. Fort Collins, Colo.: U.S. Department of Agriculture, Forest Service, Rocky Mountain Research Station. Pages 1-294 plus index.137
Ott J E, Cox R D, Shaw N L (2017) Comparison of Postfire Seeding Practices for Wyoming Big Sagebrush. Rangeland Ecology & Management 70:625-632
Pedrini S, Merritt D, Stevens J, Dixon K (2016) Seed coating: Science or marketing spin? Trends Plant Science 22:106-116 PRISM Climate Group (2018) Latest PRISM data. Available at, prism.oregonstate.edu/(accessed 13 Jul. 2018)
Pyke D A, Chambers J C, Pellant M, Knick S T, Miller R F, Beck J L, Doescher P S, Schupp E W, Roundy B A, Brunson M, Mciver J D (2015) Restoration handbook for sagebrush steppe ecosystems with emphasis on greater sage-grouse habitat—part 1. Concepts for understanding and applying restoration. 1416, Reston, Va.
Richards R T, Chambers J C, Ross C (1998) Use of Native Plants on Federal Lands: Policy and Practice. Journal of Range Management 51:625-32
Shannon G A (1979) Silo feeders and discharge drives with their related controls. IEEE Transactions on Industry Applications IA-15:348-356
Shaw N L, Debolt A M, Rosentreter R (2005) Reseeding big sagebrush: Techniques and issues. Pages 99-018 In: Shaw N L, Pellant M, Monsen S B (compilers) Sagegrouse habitat restoration symposium proceedings. USDA Forest Service RMRS-P-38 USDA Forest Service RMRS Ft Collins
Soil Survey Staff (2018) Web soil survey. URL: http://websoilsurvey.nrcs.usda.gov/(accessed 5 Feb. 2018). Washington (DC): USDA Natural Resources Conservation Service
St. John L, Tilley D, Scianna J, Jacobs J, Ogle D, Majerus M, Holzworth L (2012) Mixing seed with rice hulls. Boise, Id. and Bozeman, Mont., USA: U.S. Department of Agriculture, Natural Resources Conservation Service, Technical Note Plant Materials 7 (revised). 16 pp.
Svejcar T, Boyd C, Davies K, Hamerlynck E, Svejcar L (2017) Challenges and limitations to native species restoration in the great basin, USA. Plant Ecology 218:81-94
Taylor M H, Rollins K, Kobayashi M, Tausch R J (2013) The economics of fuel management: Wildfire, invasive plants, and the dynamics of sagebrush rangelands in the western United States. Journal of Environmental Management 126:157-173
Welch, B. L. 1996. Beyond twelve percent purity. Wild Land Shrub and Arid Land Restoration Symposium: Proceedings: DIANE Publishing. p. 126.

### APPENDIX S1

Seed Conglomeration Methods

Seeds were conglomerated in a 31 cm diameter rotary drum seed coater (Universal Coating Systems, Independence, Oreg., U.S.A.). Conglomerates were created using a mixture of Azomite®, compost, seed, water, and Agrimer SCPII binder (Ashland Inc., Covington, Ky., USA). Azomite® is a highly mineralized complex silica ore mined near Levan, Utah, U.S.A. Azomite® used based on previously-successful performance trials on conglomerates in which various clays were evaluated. Compost was made with organic yard waste from the grounds of Brigham Young University campus. Prior to use, compost was dried in a plant drier at 60° C. for 3 d and then ground in a Wiley Mill (Model 4, Arthur H. Thomas Co., Philadelphia, Pa., U.S.A.) using a 0.5 mm screen. Preliminary trials indicated that compost appeared to improve breakdown of the conglomerates after planting to allow for seedling emergence.

Conglomerates were formed by combining compost (41 g), Azomite® (388 g), and seed (43 g) in the rotary coater and while spinning the material (20% of maximum rotor speed), adding water (130 g) onto a spinning disk in the center of the seed coater at a rate of approximately 6 ml s⁻¹. Once all the water was added, a second treatment of Azomite® (194 g) was added into the rotary coater while the seeds remained spinning. During this stage, water (30 g) was added as previously described and then in the final step the liquid binder, Agrimer SCPII (20 g) was added onto the seed. Binder was added to help maintain the coating's integrity and to reduce dusting off of the conglomerates during transportation and seeding. After all the binder was applied, conglomerates remained spinning in the coater for 30 s. Conglomerates were dried for 13 min on a forced air dryer at 42° C. Seeds were then sieved through a 6.0 mm sieve to eliminate the few large masses of conglomerates.

### APPENDIX S2

Flow Rate Measurements from Broadcast Seeder

Flow rates were quantified from the broadcast seeder at different lever opening positions for control (untreated) and conglomerated seed. The Muratori 500 spreader has an adjustable lever opening position below the hopper with five settings labeled 0 through 5. The hopper is completely closed at setting 0, completely open at setting 5, and incrementally open at the intermediate settings. For each seed treatment, the hopper was opened incrementally to estimate flow rates out to approximately 1 kg PLS ha⁻¹. It was found that the change in the lever opening position has a greater effect on the seeding rate for conglomerated seed than control seed. For this reason, it was chosen to test seeding rates at lever opening positions 1, 2, 2.5, 3, 3.5, and 4 for control seed, and 0.5, 0.75, 1, 1.125, 1.25, and 1.5 for conglomerated seed. At each lever opening position, the power take off shaft (P.T.O) was run with the tractor stationary for thirty seconds. After each run, the output seed was collected, weighed, and the seeding rate was calculated. This procedure was repeated three times at each lever opening position, for each treatment, with the order of the treatments randomized. The seeding rate was calculated by multiplying the weighed output by the purity and viability of the seed to get the mass of pure live seed (PLS) output. The mass of PLS was divided by thirty seconds to produce an output rate (kg PLS s⁻¹). This value was divided by the broadcast distance of each respective treatment (control or conglomerate), and an arbitrary tractor speed of 2.5 m s⁻¹. The resulting value was the seeding rate (kg PLS ha⁻¹).

### APPENDIX S3

### Methods for Laboratory Germination and Field Emergence Trials

### Laboratory Germination

Germination of control and conglomerated seed was assessed over five constant temperatures (5, 10, 15, 20, 25° C.), in environmental growth chambers (Precision Plant Growth Chambers, Thermo Fischer Scientific, Waltham, Mass., U.S.A), under (12 h/12 h) light/dark intervals. Prior to starting germination trials, thirty ˜0.1 g samples of conglomerated seed were weighed to a thousandth of a gram, washed, and the number of seeds in the sample was counted. The same procedure was also performed for control seed. Using the seeds g⁻¹ estimation, ˜35 seeds were weighed and placed on soil inside Petri dishes. Soil was collected from a degraded Wyoming big sagebrush site approximately 10 miles south of Santaquin, Utah, U.S.A. (lat 39°54′N log 111°48′W). Soil at the site was composed of ˜42% sand, 38% silt, and 20% clay and is classified as a Donnardo-stony loam with a pH of 7.4-7.8 and 1-3% organic matter (Soil Survey Staff 2018). After collection, soil was dried at room temperature, sieved through a 1.7 mm sieve to remove excess debris, then run through a soil grinder. Water was mixed into the soil using a 1 L KitchenAid mixer (Joseph, Mich., U.S.A.), to bring the soil to field capacity (0.25 g of water for every 1.0 g soil) and 25 g of the wet soil was uniformly placed across the bottom of a Petri dish. Seeds were sown on the surface of the soil within the Petri dishes. Treatments were organized in a randomized complete block split-plot design. Temperature comprised the split-plot factor. Treatments were replicated within 10 blocks at each temperature. Each block was contained in a stack of Petri dishes, with one Petri dish for each treatment. The location of the blocks in the incubation chambers and the order of the Petri dishes in the blocks was re-randomized at least once a week.

Germination was counted every 1-3 days. Seeds that had germinated were counted, recorded, and removed from the Petri dishes. From daily germination counts, Final germination percentage, time to reach 10, 50, and 90% germination of the subpopulation (T₁₀, T₅₀, and T₉₀), and germination synchrony (T₉₀−T₁₀) were calculated. Final germination percentage was calculated by dividing the number of seeds that had germinated by the number of seeds that had been placed in the Petri dish.

Time to reach T₁₀, T₅₀, and T₉₀ was calculated as follows

$${T}_{X} = [ ( \frac{{t}_{a} - {t}_{b}}{{n}_{a} - {n}_{b}} ) ( N - {n}_{b} ) ] + {t}_{b}$$

where: Tₓ=time (days) to subpopulation germination, tₐ=incubation day when subpopulation germination was reached, t_{b}=incubation day before subpopulation germination was reached, nₐ=number of germinated seeds on day that subpopulation germination was reached, n_{b}=number of germinated seeds on day before subpopulation germination was reached, N=number of germinated seeds equal to 10, 50, or 90% of the total population.

Field Emergence

Seedling emergence of control and conglomerated seed was assessed at two locations. Field studies were planted on 4 Nov. 2016 at the same site where soil was collected. Vegetation at this site is predominantly weedy species, bulbous bluegrass (Poa bulbosa L.), and curveseed butterwort (Ceratocephala testiculata [Crantz] Roth). The second study site was planted on 5 Nov. 2016 near Lookout Pass in Tooele County, Utah, U.S.A. (lat 40°09′N, long 112°28′W). The Lookout Pass site is dominated by crested wheatgrass (Agropyron cristatum [L.] Gaertn). Prior to planting, existing vegetation was removed by spraying with 280 g ai·ha⁻¹ of glyphosate (Accord Concentrate, Dow AgroSciences, Indianapolis, Ind., U.S.A.) using a backpack sprayer with a tank pressure of ˜400 kPa, in April and again in October. The study was arranged in a randomized complete block design, where control and conglomerated seed were randomly assigned a row within each of 10 blocks. Seeds were planted in 2 m rows with 30 cm between each row. Rows were seeded with ˜250 pure live seeds m⁻¹ using a 1 Row Push Cone Planter (Kincaid Equipment, Haven, Kans., U.S.A.). Seeds were weighed out using the same seeds g⁻¹ calculation as in the laboratory trials. The cone seeder was modified so the seeds were placed onto the soil surface and the back wheel of the seeder pressed the seeds into the soil 1-3 mm deep. The total number of emerged seedlings was determined by counting individual seedlings across the length of each row.

Sagebrush seedling density in the field was analyzed using a mixed model analysis with blocks considered random and treatment, study site, and the interaction of treatment X study site being fixed factors. Long term and monthly precipitation measurements during the period of the study were derived from models developed by PRISM's (Parameter-elevation Regressions on Independent Slopes Model) Oregon Climate Service (PRISM Climate Group 2018). Annual average precipitation and temperature were estimated from 1981-2010 (FIG. 7).

### APPENDIX S4

Cost Analysis

The cost ha⁻¹ to seed sagebrush conglomerates and the control were analyzed. The total estimated cost of seeding ha⁻¹ is equal to the cost of seed plus the cost of the conglomeration treatment plus the cost of labor and the use of a tractor. The cost of seed ha⁻¹ is a function of cost kg PLS⁻¹ of seed and the seeding rate (kg PLS ha⁻¹). It was assumed the cost of seed kg PLS⁻¹ would be $29.76 and the seeding rate would be 0.2 kg PLS ha⁻¹. Costs for making the conglomerates include material costs, shipping costs (moving materials and seeds to and from the coating facilities), and labor costs (Table S1). Given that sagebrush conglomerates are a new technology, and in an effort to avoid overstating the financial savings associated with using conglomerates, it was assumed the cost to make the conglomerates would be approximately three times higher than standard seed coating costs.

Labor and tractor costs ha⁻¹ are a function of the labor and tractor costs hr⁻¹ and the number of hours required to seed one ha (hr ha⁻¹). It was assumed that labor costs to run the tractor would be $25 hour⁻¹, and the cost to operate the tractor would be $70 hr⁻¹. The hr ha⁻¹ is a function of broadcast distance, tractor speed, the time to refill a hopper, and the number of hopper refills required to seed one ha (hoppers ha⁻¹). It was assumed the broadcast seeder would spread control seed 3.09 m and conglomerated seed 6.91 m based on findings in this study. It was assumed the tractor speed would be 2.5 m s⁻¹, and that the time to refill the hopper would be 0.5 hr. The hopper ha⁻¹ is a function of the hopper volume, the seeding rate, and the kg PLS L⁻¹ of seed. It was assumed the hopper volume would be 350 L and the seeding rate would be 0.2 kg PLS ha⁻¹. Calculated was kg PLS L⁻¹ by multiplying the percent PLS of each treatment by its respective bulk density. It was assumed 30% purity and 80% viability to calculate percent PLS for untreated seed, and the conglomerate recipe was used to derive the percent PLS for conglomerates.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A conglomerate particle comprising:
small plant seeds of a seed size with a dimension less than 5 millimeters and including non-seed plant parts,
clay-binder,
aeration media.

2. A conglomerate particle as in claim 1 wherein the seeds have seed size less that 2 millimeters.

3. A conglomerate particle as in claim 2 wherein the seeds are of an Artemisia species.

4. A conglomerate particle as in claim 1 wherein the seeds the small seeds include seeds from a species of Artemisia, Achillea, Chrysothamnus, Clematis, Dasiphora, Ericameria, Eucephalus, Eurybia, Heliomeris, Lorandersonia, Picrothamnus, Pyrrocoma, Senecio, Solidago, Sphaeralcea, Symphyotrichum, Tetradymia.

5. A conglomerate particle as in claim 1 wherein the non-seed plant parts include achenes, bracts, leaves, or fine stems.

6. A conglomerate particle as in claim 1 wherein the conglomerate size is between about 2 and 4 millimeters.

7. A conglomerate particle as in claim 1 additionally comprising an additive.

8. A conglomerate particle as in claim 7 wherein the additive includes one or more components to regulate or promote seed germination and plant growth.

9. A method for producing conglomerate particles for seeding comprising:
providing a mixture of solid materials comprising small seeds of a seed size having a dimension less that 5 millimeters and including non-seed plant parts, clay-binder, and aeration media,
subjecting the mixture to centrifugal force while adding water to the mixture and continue adding water while conglomerated particles form and ceasing water addition when conglomerated particles are of sufficient size,
adding clay-binder in solid form to the wetted solid mixture,
adding further water to the clay-binder and solid mixture sufficient to further coat the conglomerated particles with clay-binder,
drying the conglomerated particles to remove water.

10. A method as in claim 9 wherein the mixture of solid materials includes an additive

11. A method as in claim 10 wherein the additive includes one or more components to regulate or promote seed germination and plant growth.

12. A method as in claim 11 wherein the small seeds are of a seed size with a dimension less than 2 millimeters.

13. A method as in claim 9 wherein the small seeds include seeds from a species of Artemisia, Achillea, Chrysothamnus, Clematis, Dasiphora, Ericameria, Eucephalus, Eurybia, Heliomeris, Lorandersonia, Picrothamnus, Pyrrocoma, Senecio, Solidago, Sphaeralcea, Symphyotrichum, Tetradymia.

14. A method as in claim 9 wherein the non-seed plant parts include achenes, bracts, leaves, or fine stems.

15. A method as in claim 9 wherein the conglomerate particle size is between about 2 and 4 millimeters.

16. A method as in claim 9 wherein the method is conducted in a rotary coater with water added by a spinning disk in the center of the seed coater.

17. A method as in claim 9 wherein a liquid binder is added to the further water.

18. A method as in claim 9 wherein the conglomerates are dried in a heated dryer.
